(19) United States
(12) Patent Application Publication
(10) Pub. No.: US 2012/0271837 A1
(43) Pub. Date: Oct. 25, 2012

(54) INTELLIGENT DATA FILTERING

(76) Inventors: Lisa M. Kryger, Wakefield, MA (US); Jeffrey H. Rick, Bedford, NH (US); Robert W. Woollam, North Reading, MA (US)

(21) Appl. No.: 13/091,266

(22) Filed: Apr. 21, 2011

(51) Int. Cl. G06F 17/30

(52) U.S. Cl. 707/751; 707/E17.014; 707/E17.044

(57) ABSTRACT

Data received from a data source is aggregated and filtered by parsing the data to determine an attribute related thereto. The data and attribute are added to a data structure that includes an automatically-generated history of a user's interaction with previously received data. A score is assigned to the received data based on its relationship to the previously received data. The data is outputted to the user if the score is greater than a threshold.

### TECHNICAL FIELD

Embodiments of the present invention generally relate to data processing, and more particularly, to automatically filtering incoming data for presentation to a user.

### BACKGROUND

As the size, content, and number of features of the Internet grow, the amount of information that a user thereof must read, review, and digest has increased accordingly. The rise in popularity of social networking sites, in particular, has greatly increased the amount of incoming data each user sees. A social-networking site, in general, connects people and allows them to share information; examples include Facebook and Twitter. A social-networking site may query users to identify others that they know and connect those users together in a common web page; the connected users may then pass messages, pictures, links, or other information back and forth.

A single user may therefore be connected to hundreds of other users on each of several social-networking sites and thus may be inundated by a flood of incoming messages and/or data. In addition, a user may subscribe to feeds (e.g., Really Simple Syndication/RSS and Atom feeds) from traditional news sources, web blogs, or other such sites, further increasing the amount of incoming data. Data may originate from the public Internet or from private networks. In order to consolidate the receipt of information from these diverse sources, a user may employ a tool called an aggregator. An aggregator is a computer program that retrieves data from many sources and presents it in a single, consolidated view. While this single view may be more convenient in some ways, it may overwhelm a user with even more incoming messages and/or data.

Some aggregators (or other similar services) may attempt to filter incoming data based on, for example, the time the data was received (e.g., older messages are ranked lower than newer messages) or by user-defined preferences (e.g., a user may specify in a preferences profile to view messages of a certain type while ignoring messages of another type). These ranking algorithms, however are either too simple (e.g., a important older message may be ranked lower than a newer, less-important message), too static (e.g., a user's preferences may change over time or a user may inadvertently block desirable content), and/or too labor-intensive (e.g., a user may not understand, or care to spend the time necessary to set up, a preferences profile). A need therefore exists for an automatic, dynamic, and intelligent ranking algorithm that presents content of interest to a user while hiding content not of interest.

### SUMMARY

In general, various aspects of the systems and methods described herein describe a data aggregator. According to an embodiment of the invention, the data (e.g., social-network posts, RSS feeds, ATOM feeds, email, and/or any other data produced by other systems) is aggregated, parsed for content, and presented to the user. Observations are made about the user's interactions with the data and a knowledge map of user preferences to data sources, authors, content, and other pieces of META information is automatically built. In addition the user's social connections, preferences to similar data are added to produce scores for each piece of data to be presented. The user is provided a volume control that allows him or her to set the minimum score that a piece of information must achieve in order to be shown.

In general, in a first aspect, a method filters data received from a data source. Data received from the data source is stored in a data store and parsed to determine an attribute related thereto. The data and attribute are added to a data structure including an automatically-generated history of a user's interaction with previously received data. A score is assigned to the received data based on its relationship to the previously received data. The data is outputted to the user if the score is greater than a threshold.

In various embodiments, the outputted data is displayed to a user. The threshold may be modified in accordance with user input, which may be captured in a volume-control interface. A type may be assigned to the relationship between the received data and the existing element, and the type maybe based at least in part on the attribute. It may be determined if other users are affected by adding the data, and the scores of the other users may be updated accordingly. Determining the attribute may include determining a word, phrase, or metadata element associated with the data. The data structure may be a knowledge map, and adding the data and attribute to the data structure may include creating a new node in the knowledge map. Adding the data and attribute to the data structure may further include adding an edge between the new node and an existing node. A type may be assigned to the edge, and the score may be based at least in part on a creation time of an edge or node.

In general, in another aspect, a system filters data received from a data source. A fetch module receives data from a data source, parses the data to determine an attribute of the data, inserts the received data and attribute into a data structure comprising previously received data, and creates a relationship, within the data structure, between the received data and the previously received data. A web module modifies the data structure in accordance with an interaction, by a user, with the previously received data. A map module computes a score for the received data based on the relationship with the previously received data and outputs the data to a user if the score is greater than a threshold.

In various embodiments, a user interface presents the outputted data to the user; the user interface may include a user control for adjusting the threshold. The system may be a server computer, and the map module may output Web-based data. The data structure may include a knowledge map that includes a node that represents the received data and/or an edge that corresponds to a relationship between the received data and the previously received data. The data source may include a social networking site, email server, RSS feed, and/or web log.

In general, in yet another aspect, an article of manufacture stores computer-readable instructions thereon for filtering data received from a data source. The instructions include storing instructions that cause a computer to store data received from a data source, parsing instructions that cause a computer to parse the received data to determine an attribute related thereto, adding instructions that cause a computer to add the data and attribute to a data structure comprising an automatically-generated history of a user's interaction with previously received data, assigning instructions that cause a computer to assign a score to the received data based on its relationship to the previously received data; and output instructions that that cause a computer to output the data to the user if the score is greater than a threshold. In various embodiments, the threshold is modified in accordance with user input and/or a type is assigned to the relationship between the received data and the existing element.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. It is to be noted, however, that the appended drawings illustrate only typical embodiments of this invention and are therefore not to be considered limiting of its scope, for the invention may admit to other equally effective embodiments. In the following description, various embodiments of the present invention are described with reference to the following drawings, in which:

FIG. 1 is a block diagram illustrating a system for collecting data and automatically presenting a subset thereof to a user in accordance with an embodiment of the present invention;

FIG. 2 is a graph illustrating records, metadata, and words/phrases related to incoming data and the relationships therebetween in accordance with an embodiment of the present invention;

FIG. 3 is a graph illustrating the addition of user actions thereto in accordance with an embodiment of the present invention;

FIG. 4 is an example of a relevancy score computation in accordance with an embodiment of the present invention;

FIG. 5 is a flowchart illustrating a method for collecting data and automatically presenting a subset thereof to a user in accordance with an embodiment of the present invention;

FIGS. 6-10 illustrate user interfaces in accordance with embodiments of the present invention; and

FIGS. 11-12 are graphs illustrating an example of an embodiment of the invention.

### DETAILED DESCRIPTION

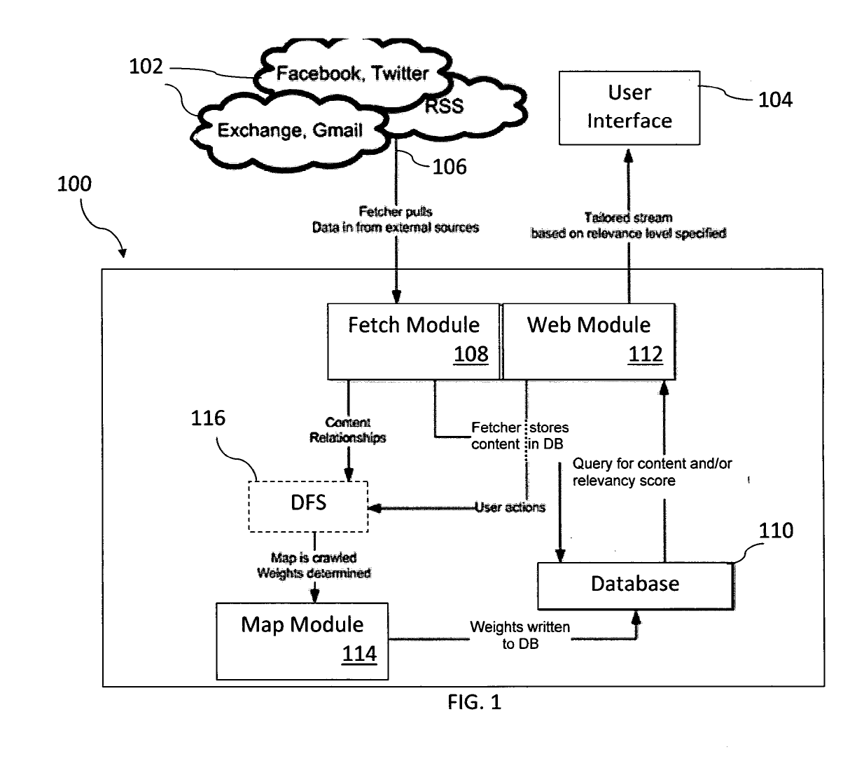

Described herein are various embodiments of methods and systems for automatically assigning a score to incoming content based on a user's interaction with previously received content and for displaying the incoming content to the user if the score exceeds a threshold set by the user or calculated by the system. One embodiment of such a system 100 appears in FIG. 1. A user subscribes or is otherwise connected to a plurality of data sources 102. The data sources may include social-networking sites like Facebook or Twitter; email services/servers like Gmail or Exchange; feeds such as RSS or Atom feeds; and/or any other type of Internet- or private-network-based news, data, or update source. The current invention is not limited to any particular source of data, as one of skill in the art will understand, and any type of data source is within the scope of the current invention. The user may subscribe to the data sources 102 and/or view the data sent therefrom via a user interface 104.

The system 100 receives the data from the external sources 102 via a network link 106, which may be a wired, wireless, cellular, and/or any other type of network connection. The user interface 104 may be disposed remotely to (i.e., connected over a network link) or may be disposed proximate the system 100. In one embodiment, the system 100 is a server (e.g., an application server) or runs on a server and the user interface 104 is a web browser (or other client-side interface) disposed on a client computer (e.g., a personal computer, laptop computer, netbook computer, tablet computer, or smartphone). In another embodiment, the system 100 is a stand-alone software application running on the client computer; in this embodiment, the system 100 may communicate with other systems 100 running on other client computers.

A fetch module 108 may receive the data automatically and/or may send a request to the sources 102 to fetch the data. The fetch module 108 communicates with the sources 102 using, for example, standard Web-based protocols like HTTP or SHTTP or via custom-designed APIs, which may be tailored for specific sources 102.

When the fetch module 108 receives the data, it stores it in a data store (i.e., database) 110. The database 110 may be any nonvolatile storage medium, such as a magnetic disk, solid-state disk, flash memory, and/or any other type of nonvolatile storage known in the art, may be an array of the same. The database 110 may be a database management system (DBMS), a relational database, and/or a relational-database management system (RDBMS).

Once the data is written to the database 110 or in parallel to writing, the fetch module 108 parses the data. In one embodiment, the fetch module 108 examines the data for certain words, phrases, symbols, and/or other alphanumeric characters appearing therein. These may be found by searching the content for words or phrases appearing in a predetermined list of keywords, by analyzing the data for frequently appearing words or phrases, by searching for words or phrases found in previously analyzed data or from other network sources, or by any other technique known in the art.

The fetch module 108 may, additionally or instead, examine and parse any metadata attached or otherwise included or associated with the incoming data. The metadata may include, for example, the identity of a parent item, the name of an author, a date of recordation, or any other such metadata.

The fetch module 108 stores a list of the determined words, phrases, and/or metadata in a data structure in a second database 116. The second database 116 may be a distributed database built on a distributed file system, or any other type of database suitable for storing and accessing large amounts of data. In various embodiments, the database 116 may be used to add content relationships (from the fetch module 108) and/or user actions (from the web module 112, as described below) to the database 116. A map module 114 (as described further below) may use the distributed file system 116 to read the contents of the database 116 in order to crawl/walk the map of the data stored therein.

In one embodiment, the data is recorded in the database 116 by creating nodes that represent the data itself (referred to herein as a record), the content words, the metadata, or any other information relating to the data. Edges may be used to connect the record to each of the nodes related to the record. These edges may be assigned a type that describes the type of connection (e.g., “contains,” “author,” “inreplyto,” etc.).

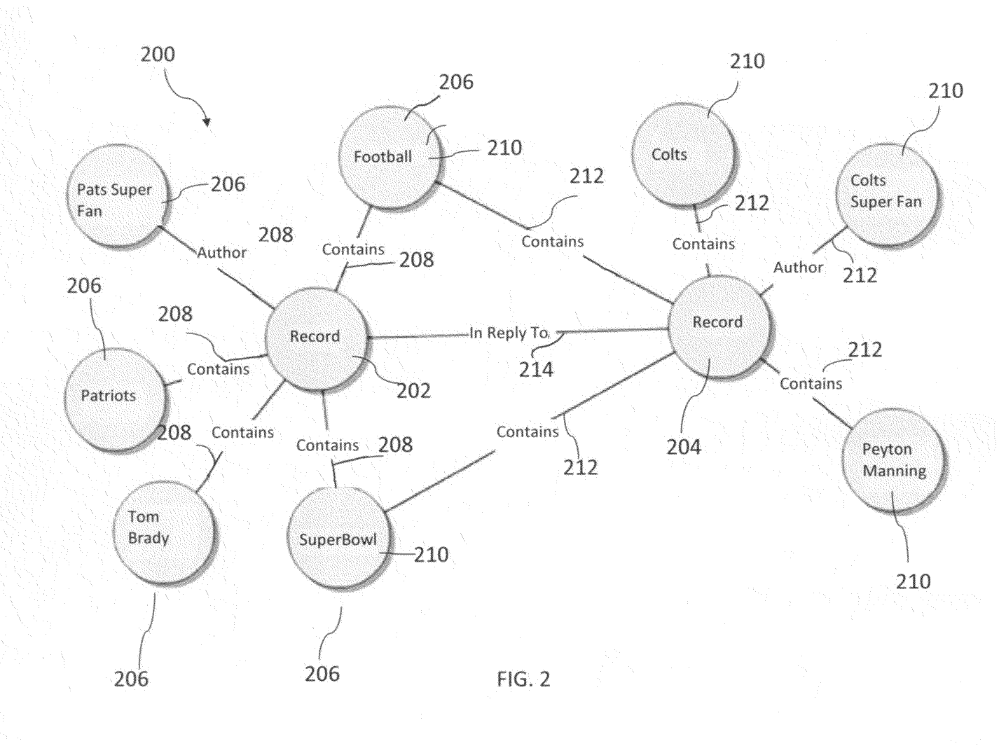

One example of such a graph 200 created by the fetch module 108 is illustrated in FIG. 2. In this example, a first record 202 already exists in the graph 200 and a second record 204 is fetched and added by the fetch module 108. The first record 202 is associated with five word/metadata items (i.e., nodes) 206 via edges 208. Each edge 208 may be labeled with an identifier specifying the relationship between the record 202 and a particular element 206. For example, some of the edges 208 specify that the record 202 contains the words “Football,” “Patriots,” “SuperBowl,” and “Tom Brady,” and that the record 202 was authored by “Pats Super Fan.”

The second record 204 is associated with five word/metadata elements 210 as determined by the fetch module 108. As the second record 204 is added to the graph 200, the fetch module 108 determines that two of the elements 210 are the same as two of the elements 206 associated with the first record 202. Rather than creating new nodes for these shared elements, the fetch module 108 creates edges 212 linking the second record 204 to the existing elements 206. Other, unique elements 210 are added and connected to the second record 204 via additional edges 212. Finally, another edge 214 links the first record 202 directly to the second record 204 and specifies a relationship therebetween (in this example, that the second record 204 was sent in reply to the first record 202). In another embodiment, no relationship between the records 202, 204 may be identified and thus no edge 214 is created. The creation of the graph 200 in this manner permits relational-based queries, such as querying the word “Football” and receiving the first 202 and second 204 records in return (due to the edges 208, 212 between the records and the word “Football”). In one embodiment, the fetch module 108 flags the first record 202 and/or the nodes 206 labeled “Football” and “SuperBowl” upon adding the second record 204 because the addition of the second record 204 modified the number of edges incident upon each of those nodes. Flagging of those nodes may signal that the relevance score of each node should be re-computed for each user affected by the change, as explained further below.

Returning to FIG. 1, a web module 112 may modify the data in the database 116 (e.g., the graph 200) by adding user interactions with the data. For example, the web module 112 may display the retrieved records to the user and allow that user to interact with the records. Any time the user interacts with the data by, for example, clicking on links, replying to emails and posts, forwarding emails, composing emails, authoring updates, and/or selecting a text trigger, the web module 112 encodes these actions into the database 116. These actions may create edges between the record and the user performing the action. The created edge may be assigned a type describing the action performed.

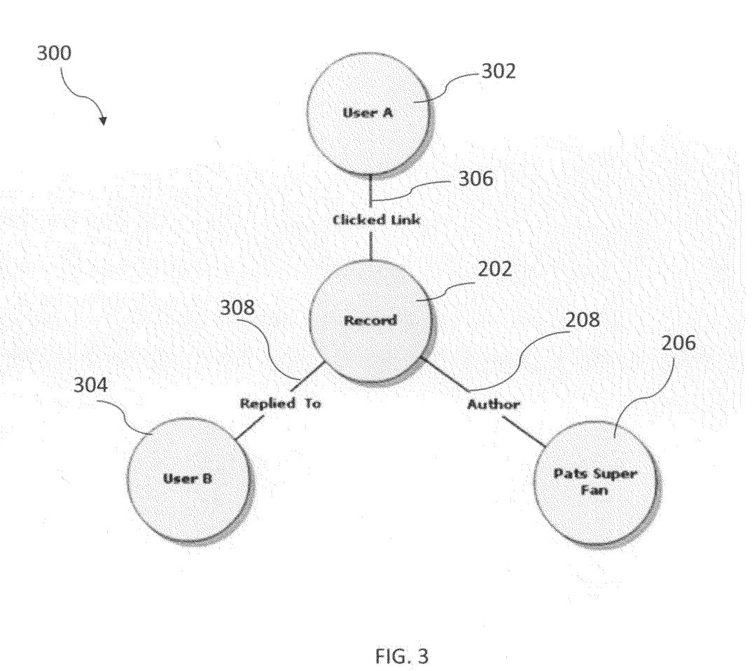

FIG. 3 is a graph 300 illustrating how the web module 112 may modify the first record 202 introduced in FIG. 2 in accordance with user interaction. Unrelated portions of the graph 200 illustrated in FIG. 2 have been removed for clarity. In this example, the record 202 appears on a user interface 104 of two different users: User A 302 and User B 304. User A 302 interacts with the record 202 by clicking a link contained therein, and the web module 112 adds a corresponding edge 306 to reflect this event. User B interacts with the record 202 by replying to it, and a corresponding edge 308 is added to connect User B 304 and the record 202. Other types of interactions may be detected, captured, and added to the graph 300 for any number of additional users. The web module 112 may detect which users are affected by any changes to the graph 300 and flag them to have their relevance scores updated, as explained further below.

Returning to FIG. 1, a map module 114 computes a relevancy score for each element of incoming data for each user based on that user's relationship to the incoming data. In one embodiment, the map module 114 analyzes the data contained in the data structure in the database 116 to do so. The map module 114 may walk the nodes and edges of the graph created by the fetch 108 and web 112 modules, as described above, to compute the relevancy scores. The map module 114 may pick one of a plurality of users out of a list of users and walk the user's graph, thereby determining all of the paths between the user and the other nodes within the graph. The algorithm may follow all edges within a certain number of degrees (e.g., two degrees) of the user's node.

As the map module 114 identifies the edges, it determines the edge type and identifies a weight for the given edge type and connected nodes. The weights may correspond to a relevance of the edge and node(s) connected thereto from the point of view of the currently considered user. For example, an “author” edge may be given a low weight if it connects to a node corresponding to an author unfamiliar to the user (i.e., the node is not connected by any other edges of relevance to the user). On the other hand, a different “author” edge may be given a high weight if it connects to a node corresponding to an author popular with the user (i.e., the node is connected to many other edges). Content-based nodes (e.g., those nodes connected by “contains” edges) may be similarly given differing weights based on number of other connected nodes/edges, relevancy of determined words/phrases, or other such metrics. A very low, zero, or negative weight may be assigned if the user interacted with data in a negative fashion (e.g., by clicking a “hide” or “dislike” button). The map module 114 then applies a formula to the edge weights and calculates an aggregate score for the connection thereto. The formula may simply sum the edge weights or may apply modifiers to the edge weights based on, for example, edge creation time, node creation time, the activity of other users, or other metrics.

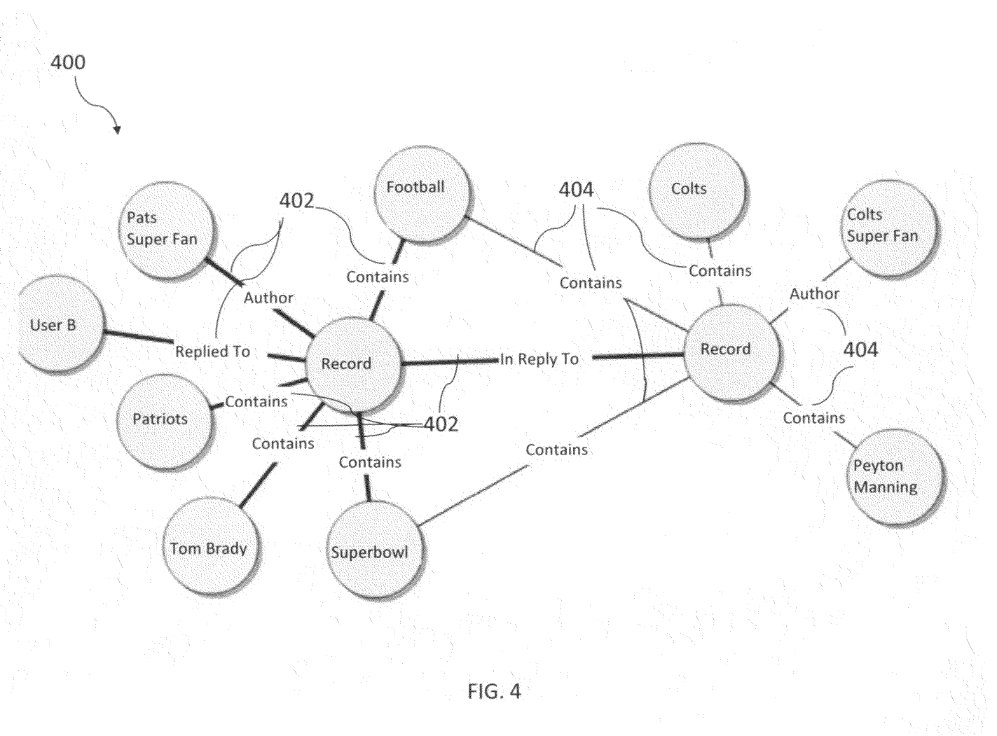

FIG. 4 illustrates an edge-weight computation 400. The highlighted edges 402 are used in the relevancy-score computation for the node 202, while the remainder of the edges 404 are not. The map module 114 may re-compute the edge weights periodically (e.g., every one, ten, 30, or 60 seconds or every 2, 5, or 10 minutes) or after the fetch 108 and web 112 modules have flagged a certain number of entries (e.g., 5, 10, or 20 flags).

The map module 114 records the aggregate scores in the database 116. In one embodiment, the scores are recorded as tuples of the user the score is for, the object it refers to, and the aggregate score. The recorded score tuples may be used by the web module 112 to retrieve the score for each of the records within the feed. The web module 112 may then transmit the results to the user interface 104 for display thereon.

The score may be used to modify the visual representation of the record on the user interface 104. For example, records with a higher score may be displayed in a larger font, in a brighter color, or with a brighter background, while records with a smaller score may be smaller and/or darker. In addition, the score may used by the web module 112 to filter records having a score lower than a minimum score selected by the user.

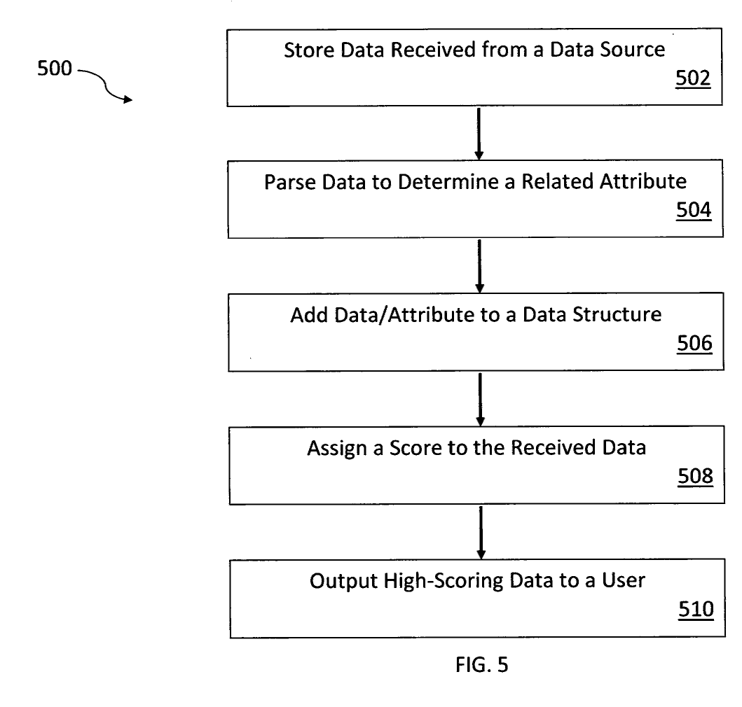

A method for filtering and presenting data to a user, in accordance with embodiments of the invention described herein, is illustrated in FIG. 5. The method 500 begins with storing (in, e.g., a data store or database) data received from a data source (Step 502). The data may be received/fetched and stored by a fetch module, as described above. The received data is parsed (by, e.g., the fetch module) to determine an attribute related thereto, for example, a word, phrase, or metadata element (Step 504). The data and/or attribute are added to a data structure (by, e.g., the fetch module) that includes an automatically-generated history of a user's interaction with previously received data (Step 506). The user interaction may be captured and added to the data structure by a web module, as described above. The received data is assigned a score (by, e.g., a map module, as described above) based on its relationship to the previously received data (Step 508). The data is then presented to the user if its score is greater than a threshold (Step 510).

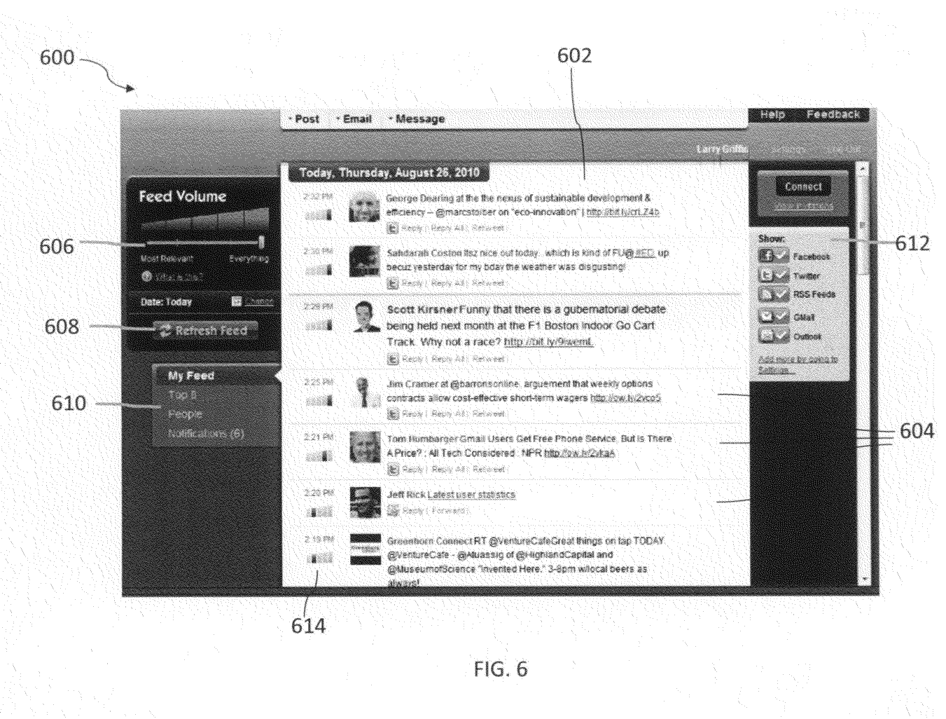

An example of a user interface 600 for displaying and/or interacting with the received data is shown in FIG. 6. A main interface window 602 displays a plurality of data entries 604, each corresponding to one record in the database 116, as described above. Each entry 604 is assigned a score and is displayed on the interface 602 only if the score is greater than a threshold. In one embodiment, a user may adjust the threshold to allow more or fewer entries 604 to be displayed by adjusting a slider control 606. If the slider is positioned at one end of its range (e.g., the far left side), only the most relevant entries 604 (i.e., ones with the greatest scores) are shown in the window 602. If the slider 606 is positioned at the other (e.g., right) end of its range, all entries 604 are shown. As the slider 606 is positioned elsewhere in its range, different quantities of entries 604 are displayed in the window 602 in accordance with their scores. For example, if the scores of the entries associated with a user are distributed evenly across a spectrum of scores and the slider 606 is positioned at one-quarter of the distance from the leftmost setting to the rightmost setting, approximately 25% of the records 604 are shown; at one-half, approximately 50% are shown; and at three-quarters, approximately 75% are shown. Other distributions of scores may lead to different quantities of entries shown at the same positions of the slider 606, however. For example, if many scores happen to be higher than average, setting the slider at its one-half setting may show more than 50% of the entries. In one embodiment, many or all of the scores are so tightly grouped that moving the slider 606 does not affect the quantities of entries shown. The scores corresponding to the position of the slider 606 may be preset in accordance with, for example, the linear position of the slider 606 or, in an alternative embodiment, set dynamically on a per-user basis in accordance with a distribution of scores for that particular user.

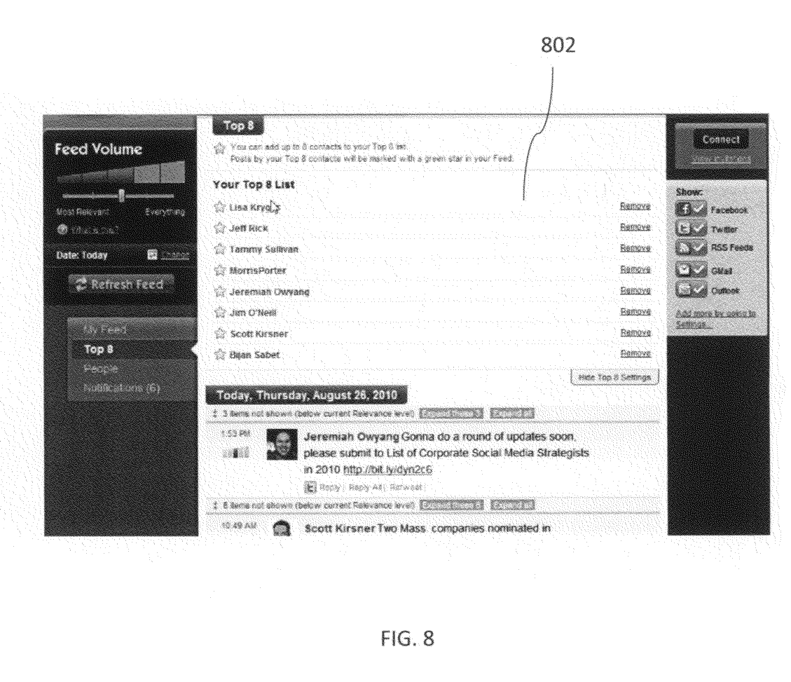

Other features of the user interface 600 include a refresh button 608 for causing an immediate fetching of new content from the user's subscribed content providers, computing a relevancy score for each new item, and/or displaying the new content in accordance with the current position of the slider 606. A window selection tool 610 enables the display of different sets of data in the window 602, including feed data, other connected users, a selection of favorite or “top” users (as explained in greater detail with reference to FIG. 8), and/or any notifications available for the user. A feed selection tool 612 provides a way to show or hide incoming data on a feed-by-feed basis. Each entry 604 may display the score 614 of that entry.

The example user interface 600 displayed in FIG. 6 illustrates a slider control 606 based on a volume metaphor. A “quiet” setting signifies that only a subset (i.e., the most relevant) of the total set of incoming data is displayed in the window 602, while a “loud” setting signifies that all of the incoming data is displayed. The current invention is not limited to any particular method of setting the threshold, however, and any appropriate method (e.g., a text-entry field, a dial, a series of radio buttons, a scrollbar, or any other such control) may be used. In one embodiment, the threshold is fixed at one value and is not adjustable by the user.

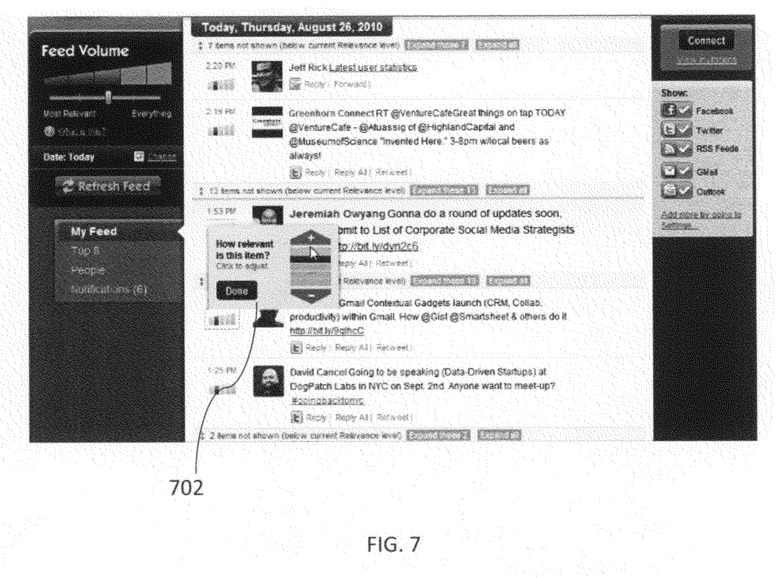

FIG. 7 illustrates a user input field 702 for manually setting a relevance of a particular item. A user may activate the input field 702 if he or she wishes to override the relevancy score set in accordance with embodiments of the invention described herein. In various embodiments, the manual setting of the relevancy score affects the item associated directly therewith and affects any other, similar records related thereto. For example, the weights of some or all edges associated with the record having the manually updated relevancy score may be lowered accordingly.

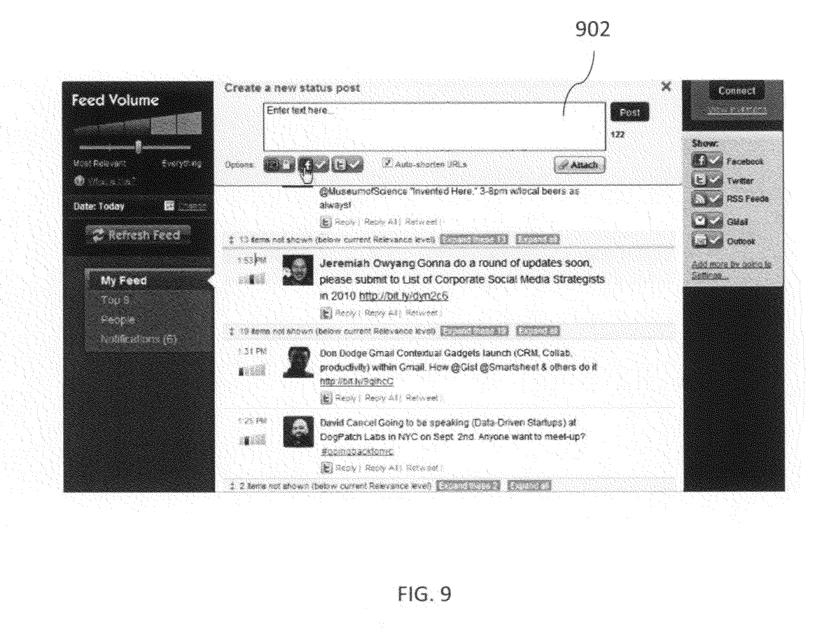

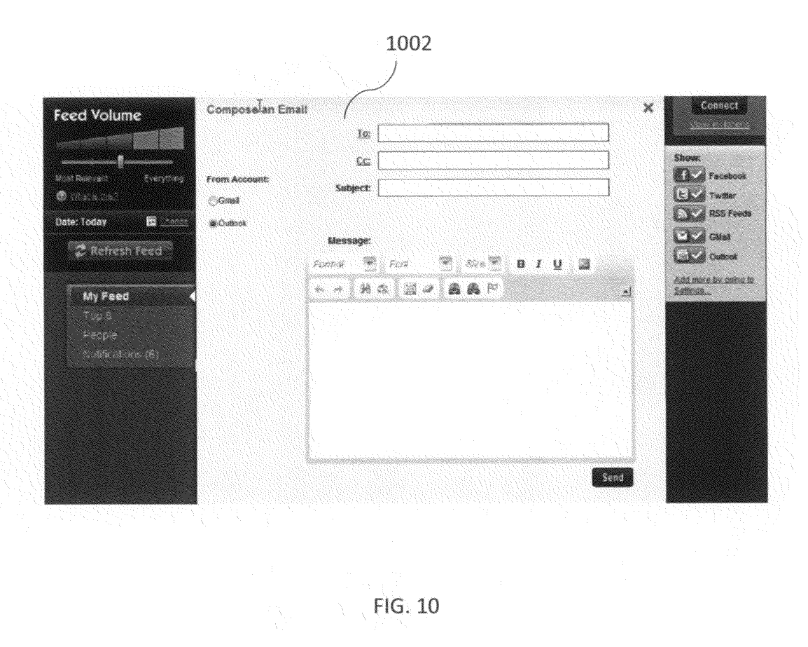

FIG. 8 illustrates a user interface element 802 for specifying one or more favorite or “top” users. Updates originating or recommended by these users may be given special consideration. In various embodiments, their updates may be always shown; their relevancy scores may be boosted by a predetermined amount; and/or edges associated with their updates may be given a higher weight. Additional features of the current invention may include an element for creating new status posts (element 902 in FIG. 9) and/or an element for composing new emails (element 1002 in FIG. 10).

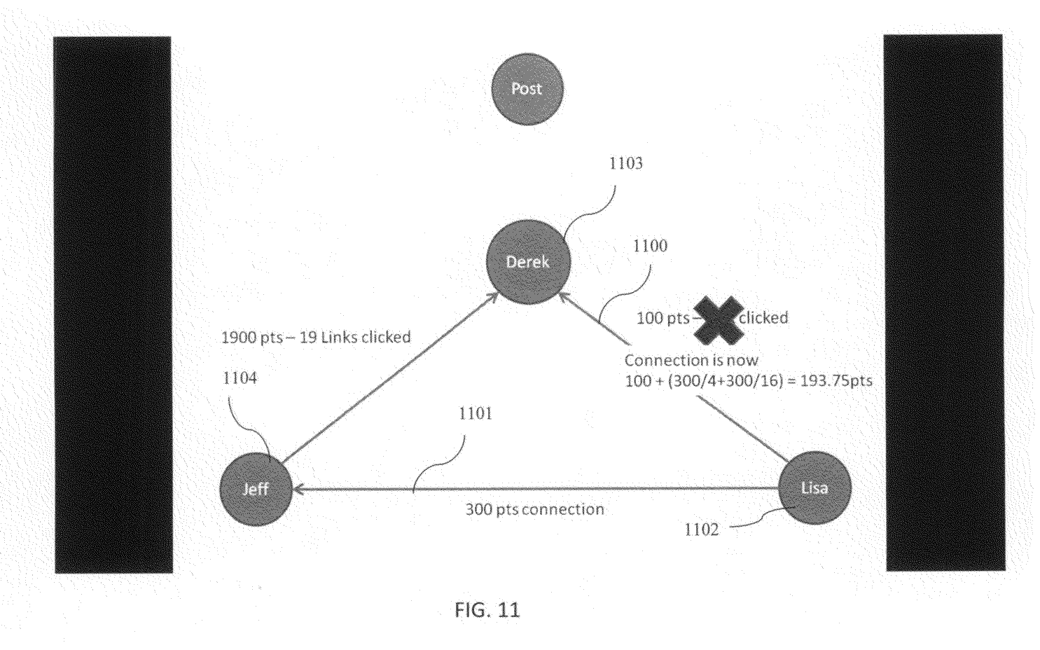

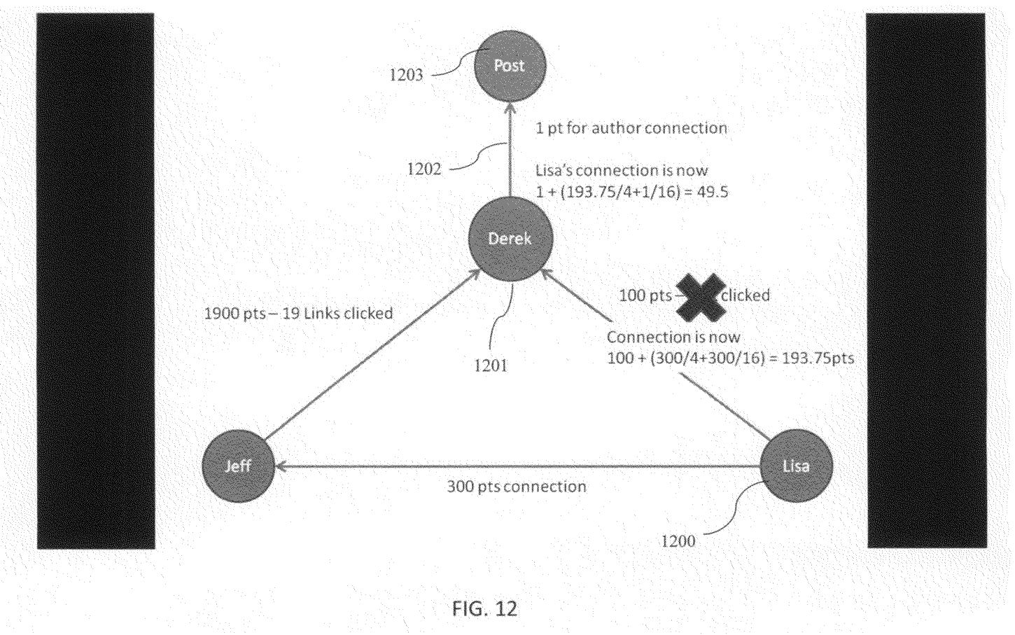

The following are examples of the operation of an embodiment of the present invention. In a first example, a user has some existing connections with two individuals. Nodes and edges that represent the connections are stored in database 116. The first edge (element 1100 in FIG. 11.) is worth 100 points because user 1102 clicked on one data item that 1103 had authored. Additionally, there is another set of edges (element 1101 in FIG. 11.) that connect user 1102 and 1104 and is worth 300 points as user 1102 clicked on three data items that 1104 had authored. In addition, user 1104 has existing edges that connect to user 1103. The total value of these edges is 1900, in this case nineteen times user 1104 click on a data item that user 1103 authored. Because there is now an additional pathway from user 1102 to 1103, through 1104 the system recalculates the value of the connection between 1102 and 1103 based on a formula. An example of this formula is to take the weight of the direct connection 100 and add to it the weight of the first leg of the indirect connection, divided by four plus the smaller weights of the two legs of the indirection connection, divided by 16. In this case the formula is 100+(300/4+300/16), where the second of the two 300s represents the smaller leg, which happens to be the first leg of the indirect connection. This score of 193.75 for the connection between users 1102 and 1103 is stored in the database 110. This process is then repeated for each of the connections in the graph. As one of skill in the art will understand, the aforementioned formula (and in particular the first constant, four, and the second constant, 16) may be modified to provide a more useful (e.g., wider) distribution of scores. In various embodiments, the first constant is a number between 1 and 6 and the second constant is a number between 10 and 20.

In a second example, the same three users have the graph described in FIG. 11 stored in database 116. Then user 1103 creates a data item that the system receives and begins to score. First the system creates edges between the data item and the author and the keywords. The system then sees the change in the graph and determines the nodes that will be affected by the change. In this case the system detects a change for user 1200 and begins the calculation. From the earlier processing described above, the connection between 1200 and 1201 was calculated at 193.75 and a new edge 1202 is created that represents the authorship of data item 1203 by user 1201. The weight associated with authorship is 1 and the system uses this in the calculation of the score. Using the same formula as described above, the relevant calculation is 1+(193.75/4+1/16)=49.5. The system takes this value and writes the connection score into database 110. The user then logs into the system and sets their filter level to, for example, level three. The system determines that the minimum score for level three is 200 and therefore the item is not outputted to that user's interface 104. In this example, however, the user lowers the threshold to level four, which the system calculates has a minimum score of 20, which allows the display of the item. The user then manually adjusts the item to be visible at level 3 which creates a new edge between user 1200 and data item 1203 and assigns a score of 200 to the item, causing its continued display even when the threshold is re-raised back to level three.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for filtering data received from a data source, the method comprising:
storing, in a data store, data received from a data source;
parsing the received data to determine an attribute related thereto;
adding the data and attribute to a data structure comprising an automatically-generated history of a user's interaction with previously received data;
assigning a score to the received data based on its relationship to the previously received data; and
outputting the data to the user if the score is greater than a threshold.

2. The method of claim 1, further comprising displaying the outputted data.

3. The method of claim 1, further comprising modifying the threshold in accordance with user input.

4. The method of claim 3, wherein the user input is captured in a volume-control interface.

5. The method of claim 1, further comprising assigning a type to the relationship between the received data and the existing element.

6. The method of claim 5, wherein the type is based at least in part on the attribute.

7. The method of claim 1, further comprising (i) determining if other users are affected by adding the data and (ii) updating scores of the other users accordingly.

8. The method of claim 1, wherein determining the attribute comprises determining a word, phrase, or metadata element associated with the data.

9. The method of claim 1, wherein the data structure is a knowledge map and adding the data and attribute to the data structure comprises creating a new node in the knowledge map.

10. The method of claim 9, wherein adding the data and attribute to the data structure further comprises adding an edge between the new node and an existing node.

11. The method of claim 10, further comprising assigning a type to the edge.

12. The method of claim 10, wherein the score is based at least in part on a creation time of the edge or a creation time of the node.

13. A system for filtering data received from a data source, the system comprising:
a fetch module for (i) receiving data from a data source, (ii) parsing the data to determine an attribute of the data, (iii) inserting the received data and attribute into a data structure comprising previously received data, and (iv) creating a relationship, within the data structure, between the received data and the previously received data;
a web module for modifying the data structure in accordance with an interaction, by a user, with the previously received data; and
a map module for computing a score for the received data based on the relationship with the previously received data and for outputting the data to a user if the score is greater than a threshold.

14. The system of claim 13, further comprising a user interface for presenting the outputted data to the user.

15. The system of claim 13, wherein the system is a server computer, and the map module outputs Web-based data.

16. The system of claim 13, wherein the data structure comprises a knowledge map.

17. The system of claim 14, wherein the knowledge map comprises a node that represents the received data.

18. The system of claim 14, wherein the knowledge map comprises an edge that corresponds to a relationship between the received data and the previously received data.

19. The system of claim 13, wherein the data source comprises a social networking site, email server, RSS feed, or web log.

20. The system of claim 13, wherein the user interface comprises a user control for adjusting the threshold.

21. An article of manufacture storing computer-readable instructions thereon for filtering data received from a data source, the article of manufacture comprising:
storing instructions that cause a computer to store data received from a data source;
parsing instructions that cause a computer to parse the received data to determine an attribute related thereto;
adding instructions that cause a computer to add the data and attribute to a data structure comprising an automatically-generated history of a user's interaction with previously received data;
assigning instructions that cause a computer to assign a score to the received data based on its relationship to the previously received data; and
output instructions that that cause a computer to output the data to the user if the score is greater than a threshold.

22. The method of claim 21, further comprising modifying the threshold in accordance with user input.

23. The method of claim 21, further comprising assigning a type to the relationship between the received data and the existing element.
